(19) United States
(12) Patent Application Publication
(10) Pub. No.: US 2025/0031744 A1
(43) Pub. Date: Jan. 30, 2025

(54) Methods and Compositions for Managing Blood Glucose Levels Using Rare Sugars

(71) Applicant: DiaVita Therapeutics LLC, Williamsburg, VA (US)

(72) Inventors: Jason P. McDevitt, Williamsburg, VA (US); Thomas Ritz, Chesterland, OH (US); Gary Ritz, Chesterland, OH (US)

(21) Appl. No.: 18/781,489

(22) Filed: Jul. 23, 2024

Related U.S. Application Data
(60) Provisional application No. 63/564,953, filed on Mar. 13, 2024.
(60) Provisional application No. 63/515,168, filed on Jul. 24, 2023.

(51) Int. Cl. A23L 33/00; A23L 33/105; A23L 33/125

(52) U.S. Cl. CPC A23L 33/30; A23L 33/105; A23L 33/125

(57) ABSTRACT

A nutraceutical composition includes a synergistic combination of tagatose and allulose for improving glycemic control in people with diabetes and prediabetes, as well as those at risk of developing metabolic syndrome. The combination is supplemented with an agent that reduces gastrointestinal discomfort, and optionally includes vitamins, minerals, and/or other dietary ingredients. The nutraceutical composition is preferably administered before meals to people with diabetes, prediabetes, metabolic syndrome, or anyone who wishes to reduce development of insulin resistance. Therapeutic benefits include a reduction of one or more of average blood glucose levels, insulin resistance, A1C percentages, hyperglycemic episodes, body weight, and time spent outside of a normal blood sugar range.

### CROSS-REFERENCE TO RELATED APPLICATIONS

The present application claims priority under 35 U.S.C. § 119(e) to (i) U.S. Provisional Patent Application No. 63/515,168 filed Jul. 24, 2023, and (ii) U.S. Provisional Patent Application No. 63/564,953, filed Mar. 13, 2024. The entire disclosures of these applications are incorporated by reference herein.

### FEDERALLY SPONSORED RESEARCH AND DEVELOPMENT

Not applicable.

### BACKGROUND OF THE INVENTION

Glucose is the primary provider of energy for the normal functions of the human body. Glucose supports the functions of both the brain and red blood cells. Humans will involuntarily elevate blood glucose in response to low blood glucose levels (hypoglycemia) in two fashions. Glucose is stored by the liver, as glycogen, and is converted back to glucose through a process known as glycogenolysis. The liver also fabricates glucose in a process known as gluconeogenesis.

High blood sugar is known as hyperglycemia. The pancreas of a non-diabetic person will involuntarily secrete insulin based on blood glucose level (also referred to as blood sugar level) and the amount of carbohydrates ingested. This prevents the onset of hyperglycemia. Therefore, glucose and insulin work in tandem to regulate the body's blood sugar level so that the body can carry out its normal functions.

The regulation of high and low blood sugars for diabetics is the primary challenge for the management of diabetes. People with type 1 diabetes (“T1D”) are unable to produce insulin, and therefore must use external sources of insulin at specific time intervals to manage both their body's normal functions and to allow them to consume carbohydrates and fats. People with type 2 diabetes (“T2D”) make insulin but do not process it properly. According to the American Diabetes Association, in 2015 there were roughly 30 million Americans with diabetes, of which approximately 1.25 million had T1D.

The consumption of carbohydrates and administration of insulin is a precarious balancing act for a person with type 1 diabetes, with the ultimate goal being a blood sugar level between 60-180 mg/dL, or preferably between 70-130 mg/dl. Management of proper blood sugar levels is difficult to achieve and typically entails a strict regimen including proper diet, regular exercise, carbohydrate counting, frequent blood sugar monitoring, regular injections of insulin, and other factors specific to each individual. For a person with T1D, injectable insulin is the primary means of lowering blood sugar level.

Hypoglycemia has a variety of dangerous effects on the health of a diabetic person. A hypoglycemic blood sugar level varies from person to person and is often defined as any level less than 60 mg/dL. Hypoglycemia is treated with high amounts of short-acting, high-sugar carbohydrates. There are also numerous nutraceuticals and pharmaceuticals commercially available for treating hypoglycemia. These include pills, gels, liquids, powders, and injectables. Sugary foods can also be used. Correction of a low blood sugar often takes anywhere between 15 to 30 minutes.

High blood sugar is defined herein as a blood sugar level greater than 180 mg/dL. A hyperglycemic blood sugar level is defined herein as a blood sugar level greater than 250 mg/dL. Short-term effects of hyperglycemia include fatigue, headache, blurred vision, diabetic ketoacidosis, and reduced insulin effectiveness. Long-term effects include cardiovascular disease, nerve damage, kidney damage, retinopathy, higher risk of infection, and memory loss.

The medium-term cumulative effects of hyperglycemia can be approximated by the hemoglobin A1C test, also referred to as A1C or glycated hemoglobin. Glucose attaches to hemoglobin in blood cells, and the higher the glucose level in the blood, the more glucose will attach to hemoglobin. The A1C test measures the amount of hemoglobin having attached glucose and correlates with average blood glucose levels over the preceding three months. According to the National Institute of Diabetes and Digestive and Kidney Diseases (NIDDK) within NIH, the A1C test is the primary test used for diabetes management, normal A1C levels are below 5.7%, and people with diabetes typically have A1C levels above 6.5%. People with T1D often have high A1C levels because they frequently become hyperglycemic and do not quickly return to a normal blood sugar level.

Relative to the rest of the population, people with T1D can have a lower quality of life due to a much higher risk of conditions such as retinopathy, kidney damage, neuropathy, and cardiovascular issues. NIDDK funded the landmark Diabetes Control and Complications Trial (DCCT, see https://www.niddk.nih.gov/about-niddk/research-areas/diabetes/blood-glucose-control-studies-type-1-diabetes-dcct-edic) to determine if people with type 1 diabetes who kept their blood glucose levels as close to normal as reasonably possible with intensive treatment could slow the development of eye, kidney, and nerve disease, compared with people who used conventional treatment at the time of the study. The study ended after 10 years in 1993, showing that people with T1D who used intensive treatment substantially lowered their A1C levels (to 7% versus 9% in the conventional treatment group) and lowered their risk of diabetic eye disease by 76 percent, diabetic kidney disease by 50 percent, and diabetic nerve disease by 60 percent.

A follow-up to the DCCT known as the EDIC study continued to follow participants in the DCCT study for over 20 years (see Jacobson, A., Braffett, B., Cleary, P., Gubitosi-Klug, R., & Larkin, M. (2013), “The Long-Term Effects of Type 1 Diabetes Treatment and Complications on Health-Related Quality of Life: A 23-year follow-up of the Diabetes Control and Complications/Epidemiology of Diabetes Interventions and Complications Cohort”, Diabetes Care, 36(10), 3131-3138. doi: 10.2337/dc12-2109). The EDIC study showed that early and intensive blood glucose control during the DCCT substantially lowered the risk over the following 20 years of cardiovascular disease and related deaths, eye surgery for diabetic disease, kidney disease, and nerve problems. The significant reduction in diabetic complications occurred even though the control and treatment groups had similar blood glucose levels and average A1C percentages for the period after the DCCT study ended. Importantly, DCCT participants in the treatment group (tight, aggressive management of blood glucose) lived longer than participants in the conventional treatment group.

Tagatose and allulose are rare sugars which have been demonstrated in many human clinical studies to have beneficial effects for people living with diabetes (Ahmed A. et al., “Rare sugars and their health effects in humans: a systematic review and narrative synthesis of the evidence from human trials”, Nutr Rev. 2022; 80(2):255-270. doi:10.1093/nutrit/nuab012.). Tagatose and allulose have been shown independently to improve the glycemic profile of diabetic patients. They are naturally occurring, low-glycemic sugars which have been used to varying extents in the food industry. Numerous studies have shown that tagatose and allulose can help regulate glucose metabolism and provide support in maintaining glucose homeostasis in patients with diabetes.

A number of plant products have been demonstrated to both (i) alleviate upset stomachs and (ii) reduce average blood glucose or A1C levels in diabetic subjects, including but not limited to fennel, ginger, cinnamon, licorice root, and peppermint.

Prolonged periods of hyperglycemia can be harmful to health, both in the short-term and long-term. There is a clinical need for methods and compositions useful for preventing, reducing the likelihood, reducing the duration, and reducing the magnitude of high blood sugar events in people with diabetes and/or metabolic syndrome, as well as preventing development of insulin resistance in people without metabolic syndrome or its associated diseases.

### SUMMARY OF THE INVENTION

This disclosure relates to methods and compositions for managing blood sugar levels, not only for people with diabetes or prediabetes, but also for people without metabolic syndrome who want to avoid development of metabolic syndrome or insulin resistance. The methods and compositions can reduce the number and magnitude of hyperglycemic episodes, reduce a person's average blood sugar levels over a given period, reduce the total time spent outside of a normal blood sugar range, reduce A1C percentages, reduce insulin resistance, reduce triglycerides, and/or reduce external insulin consumption. This disclosure provides a method comprising administering to a human being a therapeutically effective dose of a nutraceutical composition comprising: (i) allulose, (ii) tagatose, and (iii) an agent (e.g., ginger) that calms upset stomachs, wherein the composition is administered in conjunction with consumption of a meal, and preferably prior to consumption of a meal. The nutraceutical composition can be in the form of a dietary supplement or a functional food.

Accordingly, the nutraceutical composition can be in a form common for dietary supplements including but not limited to a pill, capsule, tablet or gummy, or it can be in more traditional food form including a candy, gum, powdered drink mix, bar, bite, coated plant products, or any other suitable form.

In preferred embodiments, at least two therapeutically effective doses of said nutraceutical composition are administered per day for a period of at least two weeks. In preferred embodiments, at least two therapeutically effective doses of said nutraceutical composition are administered prior to two distinct meals (e.g., breakfast and dinner) in each day. For example, a therapeutically effective dose of said nutraceutical composition can be administered to a diabetic or pre-diabetic subject within about 30 minutes prior to each meal of the day. In some embodiments, said nutraceutical composition comprises between about 1 g allulose and 14 g allulose, between about 1 g tagatose and 14 g tagatose, and between about 0.1 g ginger and 1.25 g ginger. In some embodiments, said nutraceutical composition additionally comprises multiple vitamins such that the nutraceutical composition is a multi-vitamin comprising tagatose, allulose, and ginger. In typical embodiments, the nutraceutical composition contains no added sucrose, fructose, high-fructose corn syrup, or glucose. In other embodiments, less than 1 g cumulative of sucrose, fructose, high-fructose corn syrup, or glucose is included per nutraceutical composition unit.

Tagatose and allulose have each been widely taught in the prior art to treat diabetes (for a metanalysis. Ginger has also been the subject of numerous studies, some of which have shown a benefit for glycemic control (for a metanalysis, see Huang, F. Y. et al. (2019), “Dietary ginger as a traditional therapy for blood sugar control in patients with type 2 diabetes mellitus: A systematic review and meta-analysis”, Medicine, 98(13), e15054. https://doi.org/10.1097/MD.0000000000015054.). The mechanisms by which tagatose and allulose work to help maintain glucose homeostasis are not fully understood, and multiple mechanisms of action have been proposed based on experimental studies. We have found that a combination of tagatose and allulose provides superior performance in maintaining glucose homeostasis compared to equivalent concentrations of either sugar alone.

We have also determined that administering a nutraceutical composition comprising allulose, tagatose, and ginger at therapeutically effective doses is particularly effective when administered prior to a meal, and preferably when administered prior to at least two meals per day. For example, if a total of 15 g allulose and 15 g tagatose are administered per day, enhanced glycemic control occurs with thrice-daily administration of compositions containing 5 g allulose and 5 g tagatose before each meal, as compared with a single administration per day of 15 g tagatose and 15 g allulose.

It can be advantageous to combine tagatose, allulose, ginger, and multiple vitamins into a single dietary supplement, as such a supplement enhances glycemic control while also providing beneficial vitamins. Such a supplement can be formulated as a pleasant-tasting gummy or chewable tablet, for example, which facilitates compliance with a scheduled administration before meals. Most commercially available multi-vitamins gummies have a high glycemic index which can be disadvantageous for people with diabetes. By using tagatose and allulose to provide the necessary bulking and taste typically provided by high glycemic sugars, a pleasant tasting multi-vitamin can be provided to people with diabetes which, when administered prior to meals, helps reduce post-prandial hyperglycemia. A multi-vitamin gummy or chewable tablet comprising both tagatose and allulose can be therapeutically beneficial for people with diabetes or prediabetes.

Since tagatose causes gastrointestinal (GI) discomfort in some people, it is important to include another active agent that minimizes such GI disturbances. We have determined that ginger is particularly helpful in alleviating the gastrointestinal discomfort that is a noticeable side effect of tagatose, especially at higher concentrations of tagatose. Ginger has the additional benefit that independently it may have modest benefits on A1C levels. Other agents that help prevent or quell upset stomachs, including but not limited to mint (including peppermint), licorice (e.g., licorice root and deglycyrrhizinated licorice), cinnamon, and fennel, can be used instead of or in addition to ginger.

For example, in open-label clinical testing, a subject with type 1 diabetes was administered a nutraceutical composition comprising tagatose, allulose, and ginger prior to breakfast, lunch, and dinner. Over a two-week period, the subject's blood sugar levels never exceeded 250 mg/dL (defined herein as a hyperglycemic level), which to the subject's knowledge, was the first two-week period in nearly three decades living with type 1 diabetes when his blood sugar levels never reached 250 mg/dL.

In one embodiment, a method is described for treating a human subject with diabetes or prediabetes wherein within a given day the subject sequentially (i) self-administers a nutraceutical composition comprising tagatose, allulose, and ginger, (ii) begins to eat a meal such as breakfast, lunch, or dinner within 30 minutes of self-administration of said nutraceutical composition, (iii) waits more than two hours during which time the subject does not administer a nutraceutical composition comprising tagatose, allulose, and ginger, (iv) self-administers a second nutraceutical composition comprising tagatose, allulose, and ginger, and (v) begins to eat a meal such as breakfast, lunch, or dinner within 30 minutes of self-administration of said second nutraceutical composition. Preferably, this cycle is repeated every day for at least two weeks. In some embodiments, the nutraceutical composition is a multi-vitamin dietary supplement comprising tagatose, allulose, and ginger. For example, in one embodiment, the dietary supplement is a multivitamin comprising between 0.5 and 14 g tagatose, between 0.5 g and 14 g allulose, and between 100 mg and 1 g ginger. In other embodiments, the nutraceutical composition is a food item with a sweet taste comprising between 0.5 and 14 g tagatose, between 0.5 g and 14 g allulose, and between 100 mg and 1 g ginger (including for example ginger powder, raw ginger, or ginger extract) which is eaten before meals by people with diabetes, people with metabolic syndrome, and also by people who simply want to avoid metabolic syndrome.

The methods described herein can improve the management of diabetes, including both type 1 diabetes and type 2 diabetes. The methods of the disclosure can reduce the time and magnitude of hyperglycemic episodes, and thus also reduce the unpleasant symptoms of hyperglycemia, which sometimes include headache, frequent urination, increased thirst, fatigue, nausea, shortness of breath, and general discomfort. Accordingly, the methods of the disclosure can significantly reduce short-term health complications of diabetes and can even reduce the costs associated with diabetes since insulin consumption can decrease significantly for people with type 1 diabetes when the claimed supplements are administered according to the methods described herein. The methods described herein can also be used to treat metabolic syndrome, and also to help prevent its occurrence and/or reduce insulin resistance or development of insulin resistance, including in healthy individuals who do not have metabolic syndrome.

Moreover, the methods of the disclosure can significantly reduce the long-term health complications of diabetes. In some embodiments, the sequential steps described above (e.g., self-administering the nutraceutical composition at least twice in a given day prior to meals) are repeated most days during a week, month, year, or even multiple years. By repeatedly reducing the duration and magnitude of hyperglycemic episodes, the methods could decrease hemoglobin A1C percentage in a diabetic patient relative to the hemoglobin A1C percentage if the methods described herein were not used, and can reduce long-term health complications associated with diabetes, including retinopathy, kidney damage, neuropathy, or cardiovascular issues, and shortened lifespans.

A dietary supplement comprising tagatose and allulose, for example, a multi-vitamin comprising tagatose, allulose, and ginger, can have a wide variety of compositions. In many embodiments, such supplements are administered in the form of gummies. Prior to a meal, a diabetic subject could eat a single large gummy, or multiple small gummies. Many children have diabetes, and children typically are smaller than adults and therefore require less of the active ingredients to obtain a therapeutic benefit. Accordingly, the dosage of active ingredients in each supplement composition can have a wide range.

Additional active or inactive ingredients can be incorporated into said nutraceutical compositions. For example, ingredients that contain fat, protein, or fiber can be incorporated into said nutraceutical compositions. For example, in one embodiment, the nutraceutical composition is a chocolate candy comprising tagatose, allulose, ginger, cacao powder, and other ingredients. In another embodiment, the nutraceutical composition is a powdered pudding mix comprising chia seeds, tagatose, allulose, psyllium, ginger root powder, and optionally other ingredients.

According to the methods, in some embodiments, the cumulative dosage of tagatose and allulose administered prior to a given meal is between about 1 g per 25 kg body weight of the subject and 8 g per 25 kg body weight, wherein the weight ratio of tagatose to allulose in the nutraceutical composition is between 0.25 and 4.0. This dosage can be administered in a single nutraceutical composition unit (such as a pill, capsule, lozenge, gummy, tablet, candy, wafer, powder, freeze-dried snack, bar, extruded product, or dried food), or it can be administered in multiple units (e.g., administered as two gummies). For example, in one embodiment, a multivitamin gummy comprises a multitude of vitamins, minerals, and other nutritional ingredients (at dosages less than or equal to half the recommended daily allowance), in addition to 5 g tagatose, 2.5 g allulose, and 200 mg ginger.

In some embodiments, the cumulative amount of tagatose and allulose in each nutraceutical composition unit is between about 5 g and about 15 g. Multiple nutraceutical compositions as described herein can be consumed before any given meal, or just a single nutraceutical composition can be consumed. For example, a nutraceutical composition in candy wafer form containing 3 g allulose and 3 g tagatose (in addition to ginger and cinnamon) could be administered prior to each of three meals per day. Alternatively, a subject could choose to administer, for example, two of these candy wafers prior to both breakfast and dinner.

Advantages of the methods can include, but are not limited to, a reduction in the time a person spends in a hyperglycemic state over the course of a day, a week, a month, or a year; a reduction in time spent outside of the normal blood glucose range; a reduction in hypoglycemia resulting from overcorrections with insulin; a reduction in medical costs; a reduction in an individual's hemoglobin A1C percentage (A1C %); a reduction in stress related to blood glucose levels; an improvement in diabetes management; an improvement in a person's health and well-being; a reduction in cumulative damage from hyperglycemia; a reduction in complications from retinopathy, kidney damage, neuropathy, or cardiovascular issues; a reduction in metabolic syndrome symptoms or complications, a reduction in insulin resistance, a reduction in body weight, a reduced likelihood of diagnosis with metabolic syndrome or diabetes, and an increase in lifespans.

The methods of the disclosure are applicable to individuals having type 1 diabetes, type II diabetes, prediabetes, any other conditions that give rise to frequent hyperglycemic states, as well as to anyone interested in better metabolic health.

### BRIEF DESCRIPTION OF DRAWINGS

Not applicable.

### DETAILED DESCRIPTION OF THE INVENTION

As used herein, each of the following terms has the meaning associated with it as described below.

The articles “a” and “an” are used herein to refer to one or to more than one (i.e. to at least one) of the grammatical object of the article. By way of example, “an element” means one element or more than one element.

As used herein, “plurality” means at least two.

As used herein, “FDA” means the United States Food and Drug Administration.

Any ranges cited herein are inclusive, e.g., “between about 50 mg and 100 mg” includes compositions of 50 mg and 100 mg.

As used herein, a human being, also referred to as a human subject, or as a subject, is “treated”, or subjected to “treatment”, when an earnest attempt is made to alleviate a medical disorder or disease. For example, a subject can be treated for a disorder by being administered a pharmacologic agent that is intended to alleviate the disorder, irrespective of whether the treatment actually was successful in alleviating the disorder.

As used herein, a disease or disorder or medical affliction is “alleviated” if either the severity of a symptom of the disease or disorder or medical affliction, the frequency with which such a symptom is experienced by a subject, or both, are reduced.

A “subject” of diagnosis or treatment is a human.

A “therapeutic” treatment is a treatment administered to a subject who exhibits signs of pathology for the purpose of diminishing or eliminating those signs.

A “therapeutically effective amount” of a compound (or composition containing the compound) is that amount of compound which is sufficient to provide a beneficial effect to the subject to which the compound is administered.

An “upset stomach”, also referred to as “gastrointestinal discomfort”, refers to a disorder of digestive function characterized by discomfort or heartburn or nausea or excess gas or bloating.

A “dietary supplement” is an addition to the human diet, which is not a natural or conventional food, and which can be therapeutically effective when used according to the methods of the invention. Note that the dietary supplement can include ingredients which are conventionally used in food, including as preservatives, but the compositions as described are not typically consumed alone as food.

A “functional food” is a food item that contains one or more health-promoting component(s) beyond traditional nutrients, and includes beverages.

A “nutraceutical composition” can be either a functional food or a dietary supplement.

Diabetes, also referred to as diabetes mellitus, is a chronic disease characterized by poor regulation of blood glucose in the body of a diabetic subject. People living with type 1 diabetes do not produce insulin (or make very little of it). People living with type 2 diabetes make insulin, but do not process it properly. When a person is described as having “prediabetes”, it means that individual has higher than normal blood sugar levels. While these elevated blood sugar levels are typically not high enough to be considered type 2 diabetes, without lifestyle changes, adults and children with prediabetes, also referred to as prediabetic persons, are at high risk to develop type 2 diabetes.

A “blood glucose level”, alternatively referred to as a blood sugar level, is defined as the amount of glucose in a subject's blood, measured in mg/dL. A normal blood glucose level two hours after eating typically does not exceed 140 mg/dL. A high blood sugar level is defined herein as a blood glucose level greater than 180 mg/dL, and a hyperglycemic blood glucose level is one that is greater than 250 mg/dL. The term “hypoglycemic” is defined as a blood glucose level of 60 mg/dL or lower (also referred to as “low blood sugar”), and a blood glucose level below 50 mg/dL is deemed a “very low” blood glucose level.

The term “shorter-acting” insulin means an insulin having an onset of insulin effect within one hour of administration, and therefore includes insulins that are typically classified as either rapid-acting insulins or short-acting insulins. The term “longer-acting” insulin means an insulin having an onset of insulin effect of 60 minutes or more. Such longer-acting insulins typically have a duration of action of at least 12 hours, whereas shorter-acting insulins typically have a duration of action of less than 10 hours. Bolus insulins are almost always shorter-acting insulins. Some diabetics use a mixture of shorter-acting and longer-acting insulin.

The term “metabolic syndrome” refers to a cluster of conditions that occur together, increasing the risk of downstream diseases including heart disease, stroke, obesity, fatty liver disease, and type 2 diabetes. The primary components or risk factors associated with metabolic syndrome include: (i) excess fat in the abdominal area, often indicated by an increased waist circumference; (ii) elevated blood pressure, typically defined as equal to or greater than 130/85 mm Hg; (iii) high blood sugar indicating insulin resistance or impaired glucose metabolism; (iv) high triglyceride levels, and (v) low levels of high-density lipoprotein (HDL) cholesterol; wherein having three or more of these factors is usually indicative of metabolic syndrome.

Many studies have demonstrated the benefits of tagatose for people with diabetes. Many studies have demonstrated the benefits of allulose for people with diabetes. To our knowledge, there are no studies that have demonstrated the synergistic benefits of a combination of tagatose and allulose.

The mechanisms by which tagatose and allulose improve glycemic control are not completely understood, and many different mechanisms may have an influence. For example, allulose inhibits the digestive enzyme α-glucosidase, which may contribute to its impact. Allulose inhibits the absorption of glucose from the intestine by competition with glucose transporter 2 (GLUT2) on the basolateral membrane of the intestinal epithelial cells, which may contribute to its impact. Allulose can induce hepatic glucokinase to increase glucose utilization in the liver, which may contribute to its impact. Allulose can alter the gut microbiota composition, for example by increasing concentrations of Lactobacillus and Coprococcus, which may contribute to its impact. Similar mechanisms have been proposed to account for the impact of tagatose on glycemic control in people with diabetes. It is likely that multiple mechanisms contribute, and the relative contributions of these different mechanisms can vary by individual. Without wishing to be bound by theory, it is hypothesized that a combination of tagatose and allulose provides an enhanced breadth and depth of mechanisms that contribute to glycemic control such that the impact of the tagatose plus allulose combination is greater than the impact of either component by itself at the same cumulative concentration. Accordingly, it is advantageous to co-administer tagatose with allulose.

Both tagatose and allulose can give rise to significant gastrointestinal side effects (e.g., bloating, flatulence, abdominal pain, diarrhea). In our personal experience and anecdotally, the GI side effects are more significant for tagatose than allulose. For example, an attempt was made to conduct an experimental treatment with tagatose alone (i.e., no co-administration of allulose or ginger), and that experimental treatment was stopped after a couple of days because of the unpleasant GI side effects reported by a majority of subjects.

In tests we conducted, the GI side effects from tagatose were substantially reduced by co-administration with sufficient quantities of ginger. The GI side effects from tagatose may wane over time with continued use for a period of weeks or more, but it is hard for a subject to reach long-term use when the initial side effects are so unpleasant. Accordingly, it is advantageous to co-administer ginger, or other agents that quell stomach discomfort, with tagatose.

In some embodiments, one or more other agents useful for treating gastrointestinal discomfort can be utilized instead of or in addition to ginger. Suitable agents include but are not limited to fennel, licorice, cinnamon, and mint. A particularly suitable mint is peppermint. Particularly suitable forms of licorice include licorice root and deglycyrrhizinated licorice. For example, in one embodiment, a dietary supplement composition comprises 5 g allulose, 3 g tagatose, and 25 mg peppermint oil. in another embodiment, a functional food composition comprises 6 g allulose, 2 g tagatose, and 200 mg licorice root. When licorice root is administered in conjunction with tagatose and allulose before meals, the total licorice root administered per day is between 50 mg and 2 g. When peppermint oil is administered in conjunction with tagatose and allulose before meals, the total peppermint oil administered per day is between 5 mg and 500 mg.

The active ingredients can be combined with inactive ingredients, as well as other active ingredients, in nutraceutical compositions. In some embodiments, the combination of tagatose and allulose is combined with other ingredients, including at least one component that alleviates upset stomachs, in any suitable food or drink form. In some embodiments, the combination of tagatose and allulose is combined with at least one component that alleviates upset stomachs and other ingredients to create a dietary supplement composition in the form of a tablet, capsule, chewable tablet, or gummy. In preferred embodiments, the nutraceutical compositions do not comprise significant quantities of sweeteners having glycemic indexes above 40 (e.g., brown sugar, cane sugar, molasses, glucose, fructose, sucrose, dextrose, corn syrup, high fructose corn syrup). Sugar alcohols included but not limited to xylitol, mannitol, and sorbitol can be incorporated into the dietary supplement compositions described herein, although in all cases, the primary sweeteners are tagatose and allulose.

When the nutraceutical composition is a dietary supplement, other additives useful for tablets, capsules, or gummies can be included in the formulation, including but not limited to gelling agents such as pectin and gelatin, bulking agents, release agents, coatings, colorants, flavoring agents, binding agents, lubricants, anti-caking agents, excipients, surfactants, dispersing agents, and other additives useful in the formulation of tablets, capsules, or gummies.

When the dietary supplement composition includes vitamins, it can comprise one or more vitamins, minerals, or other dietary ingredients. Representative embodiments comprise many different vitamins, minerals, micronutrients, and other dietary ingredients as is typical in a multivitamin pill. Since the dietary supplements described herein are intended to be administered before meals, sometimes three times per day, it is advantageous to formulate a multivitamin such that each unit does not include the full recommended daily allowance of each vitamin or mineral, but rather some fraction thereof.

For example, in one embodiment, a chewable tablet comprises 5 g allulose, 2.5 g tagatose, 0.25 g ginger, 1,050 mcg vitamin A 1,050 mcg, 30 mg vitamin C, 10 mg vitamin D3, 4.5 mg vitamin E, 13 mg vitamin K, 0.5 mg thiamin, 0.5 mg riboflavin, 7 mg niacin, 0.75 mg vitamin B6, 100 mcg folic acid, 1 mg vitamin B12, 10 mg biotin, 3 mg pantothenic acid, 60 mg calcium, 6 mg iron, 10 mg phosphorus, 50 mcg iodine, 25 mg magnesium, 4 mg zinc, 20 mcg selenium, 0.1 mg copper, 0.5 mg manganese, 15 mcg molybdenum, 30 mg chloride, and 30 mg potassium in addition to additives to enhance the formulation.

In some embodiments, gummies or chewable tablets are formulated for administration on a twice-daily basis, or a thrice-daily basis. In some embodiments, gummies or chewable tablets are formulated for administration four times per day, including twice before breakfast and then twice before, or alternatively twice before breakfast, and once each before lunch and dinner. Breakfast is defined herein as the first meal of a day, lunch is defined as the second meal of the day, and dinner is defined as the final meal of a day.

The dietary supplement compositions described herein are useful when administered to people with diabetes (type 1 or type 2) or prediabetes. The dietary supplement compositions described herein can be administered to subjects with diabetes or prediabetes within about 30 minutes prior to eating meals such as breakfast, lunch, or dinner. In preferred embodiments, the dietary supplement compositions are administered before at least two meals per day, and in some cases, before three meals per day. In preferred embodiments, the dietary supplement compositions are administered before one or more meals per day for at least ten days over a two-week period, or preferably at least 20 days over a one-month period, or at least 120 days over a six-month period.

When the dietary supplement compositions are administered to a subject before meals with reasonable consistency over a three-month period, the subject can experience a lowering of average blood sugar, a reduction in hyperglycemic periods, a reduction in hyperglycemia index, and an increase in time spent in a normal blood sugar range. Additionally, some subjects might experience weight loss, reduced A1C levels, reduced consumption of insulin (for people with type 1 diabetes), reduced blood sugar fluctuations as measured by standard deviation of average blood sugar, and/or reduced periods of hypoglycemia.

When the nutraceutical composition is a functional food product, other ingredients and additives useful in food products can be included in the formulation, including any food additives or ingredients approved for use or in common use. In preferred embodiments, the carbohydrate content (not including the contribution from tagatose and allulose) of the cumulative food additives to a functional food comprising allulose and tagatose is not more than twice the fiber content.

The functional food product administered in conjunction with meals comprises (i) a plant ingredient that can soothe upset stomachs or help to prevent their occurrence, (ii) tagatose, and (iii) allulose can be, for example, a candy wafer, a sugar cube or similar dry product, a licorice-like chew, a nut butter chew, a chia pudding, a powdered mix, a drink, or any other suitable food form.

For example, in one embodiment, the functional food product is a ginger tea brewed by mixing fresh or powdered ginger root with hot water for a period of time such as ten minutes, filtering off the solids, and then adding tagatose and allulose, and served prior to meals in 8-ounce servings comprising 5 g tagatose, 5 g allulose, and the aqueous extract of 1 gram ginger.

In another embodiment, the functional food product is an almond nut butter chew comprising almond butter, chia seeds, water, tagatose, allulose, ginger, and cinnamon. The almond nut butter chews can be prepared by heating and stirring 1 cup tagatose and 1 cup allulose with ⅓ cup of water and reducing to a thick syrup. This syrup is combined with a stirred mixture of 1 cup creamy almond butter, ⅛ cup ginger powder, and % cup chia seeds. The resulting mixture is blended to a dough-like consistency and rolled, extruded, or pressed into sheets which are subjected to heating with air flow at a temperature between 60° C. and 100° C. for a sufficient period of time to remove a desired portion of the water content. The resulting product is cut into tiles and can be consumed, preferably within about 30 minutes prior to any meal. In some embodiments, sufficient water is removed to drive the water activity (aw) below 0.75, or below 0.65, or below 0.6.

In another embodiment, the functional food product comprises ginger sugar cubes, which can be prepared, for example, by combining 1 cup allulose, 0.5 cups tagatose, 3 tablespoons ginger root powder, and 2.5 teaspoons water. The ingredients are mixed to provide a damp, sand-like consistency. Portions of the mixture are compressed into silicone mold and dried at room temperature or with mild heating and air flow. After drying, the cubes are released from the mold to yield cubes weighing roughly 10 grams each.

In another embodiment, the functional food product is a powdered mix for chia pudding comprising 20 g chia seeds, 5 g tagatose, 5 g allulose, 0.4 g ginger, and 4 g psyllium husk. To the mix is added a suitable amount of a liquid such as water, milk, soy milk, oat milk, almond milk, or other liquids. The resulting slurry is typically stirred and chilled before consuming, although those steps are not necessary.

In another embodiment, the functional food product is a chocolate confection made from cacao powder, tagatose, allulose, ginger, and optionally other ingredients.

In typical embodiments utilizing a functional food or a beverage item, the user is directed to only consume a discrete quantity, such as one wafer for each 50 pounds of body weight prior to a meal. In some embodiments, the nutraceutical compositions will be packaged on a per unit basis. Unlike a bag of popcorn or chips, wherein a consumer often eats a varying amount and often consumes multiple servings, it is counterproductive to consume too much of the functional foods described herein, as it can lead to gastrointestinal discomfort. Accordingly, users are directed to consume a selected amount in conjunction with meals. It is acceptable to consume the nutraceutical composition with or even following a meal, but enhanced therapeutic benefits are obtained when the nutraceutical composition is consumed within 30 minutes prior to a meal.

### Examples

The examples that follow are intended in no way to limit the scope of this invention but are provided to illustrate the methods of the present invention. Many other embodiments of this invention will be apparent to one skilled in the art.

Example 1. A pilot, open-label observational study was conducted on a 30-year-old male subject with type 1 diabetes. The subject used a Dexcom® continuous glucose monitoring system which recorded blood sugar levels every five minutes. The subject first completed an extensive control period for roughly two months to obtain background blood sugar levels.

Subsequently, the subject was administered numerous treatment protocols separated by washout periods of at least 7 days (typically two weeks). The subject did not complete one treatment (treatment with 7.5 g tagatose prior to meals without allulose or ginger) because of GI discomfort. The subject completed treatments with the following active ingredients: (i) Experimental Treatment 1: tagatose plus allulose plus ginger, (ii) Experimental Treatment 2: tagatose plus ginger, (iii) Experimental Treatment 3: allulose plus ginger, and (iv) Experimental Treatment 4: a second treatment course comprising tagatose plus allulose plus ginger. Each of these experimental treatments was followed by a washout period.

Note that the washout periods are not equivalent to controls. It is believed that the prebiotic effect of the rare sugars continues to have an influence for some period after tagatose and/or allulose are no longer being administered. For the same reason, it is also possible (if not likely) that carryover effects have at least a slight influence upon successive experimental treatments. That said, there is also variability between periods due to air temperature, physical health, mental health, stress, sleep, etc. Obviously, conducting a clinical study with more subjects and with only a single treatment protocol would be beneficial.

In all experimental treatment periods, the treatment was administered three times per day throughout the experimental treatment period within 30 minutes prior to the start of breakfast, lunch, and dinner meals (typically within 5 minutes prior to the start of eating the meal). In all experimental treatments, a total of 7.5 g rare sugars was administered per meal, corresponding to 22.5 g per day. When both tagatose and allulose were administered as part of the experimental treatment, the dosage was 5 g allulose and 2.5 g tagatose. In all experimental treatments, a total of 0.35 g ginger (350 mg) was administered per meal, corresponding to 1.05 g ginger per day.

Blood sugar levels were recorded every five minutes using the continuous glucose monitoring system. Primary endpoints were (i) average blood sugar level over the course of treatment, (ii) number of five minute periods with blood sugar level over 180 mg/dL (“time with high blood sugar”) and (iii) “hyperglycemia index”, calculated as the fraction of time with blood sugar level over 250 mg/dL multiplied by the average magnitude of the these hyperglycemic periods (defined as the difference in mg/dL between the recorded blood sugar level and 250). In other words, if there was one hour during the day during which the blood glucose level was above 250, and the average blood sugar level during that hour was 298, then the severe hyperglycemia index would be 2.00 (i.e., 1/24×48).

The data are provided below in Table 1.

TABLE 1

| | | Time with High | | Average |
|---|---|---|---|---|
| | Duration | Blood Sugar | Hyperglycemia | Blood Sugar |
| Treatment | (days) | (minutes/day) | Index | (mg/dL) |
| Control Period | 64 | 291 | 0.66 | 145.3 |
| ET 1 (tagatose/allulose/ginger) | 7 | 206 | 0.22 | 136.9 |
| Washout Period 1 | 14 | 294 | 0.34 | 146.1 |
| ET 2 (tagatose/ginger) | 15 | 286 | 2.03 | 143.8 |
| Washout Period 2 | 7 | 265 | 0.24 | 139.1 |
| ET 3 (allulose/ginger) | 15 | 237 | 0.68 | 140.0 |
| Washout Period 3 | 13 | 322 | 1.03 | 146.2 |
| ET 4 (tagatose/allulose/ginger) | 14 | 139 | 0.00 | 123.8 |
| Washout Period 4 | 15 | 258 | 0.45 | 140.6 |

Time with hyperglycemia was the lowest, over all of the treatment periods, for the two experimental treatments that combined tagatose plus allulose plus ginger. The hyperglycemia index was also the lowest, over all of the treatment periods, for the two experimental treatments that combined tagatose plus allulose plus ginger. Average blood sugar levels were also the lowest, over all of the treatment periods, for the two experimental treatments that combined tagatose plus allulose plus ginger. For all three primary endpoints, the best results across all experimental treatments, washout periods, and the control period occurred during the two experimental treatments using tagatose plus allulose plus ginger.

The benefits of combining tagatose and allulose were significantly more than additive (again, noting that in all experimental treatments, the total amount of rare sugars administered per day was the same). In particular, the data for Experimental Treatment 4 for the severe hyperglycemia index is stunning. To the subject's knowledge, this was the first time in close to three decades living with type 1 diabetes when he went two weeks without his blood sugar level ever reaching 250 mg/dL. While the variability in data for the hyperglycemia index was substantially higher than other measures, it is worth noting that in this limited data set, the hyperglycemic index was not improved relative to control data for either the allulose plus ginger experimental treatment or the tagatose plus ginger experimental treatment.

Example 2. A pilot, open-label observational study was conducted on a 30-year-old male subject with type 1 diabetes, the same subject as in Example 1. The subject used a Dexcom® continuous glucose monitoring system which recorded blood sugar levels every five minutes. Following the completion of Example 1, the subject completed an extensive washout period for over roughly three months prior to the extended 49-day control period of this Example 2 to determine background blood sugar levels.

Subsequently, the subject self-administered nutraceutical compositions on a twice-daily basis within thirty minutes before meals, typically breakfast and dinner. The nutraceutical compositions that were ingested by the subject prior to meals comprised 7.5 g allulose, 3.75 g tagatose, and 0.5 g ginger. The treatment period extended for 73 days.

Blood sugar levels were recorded every five minutes using the continuous glucose monitoring system. Primary endpoints were (i) average blood sugar level over the course of treatment, (ii) percentage of time with blood sugar level over 180 mg/dL (“time with high blood sugar”), (iii) percentage of time with blood sugar level above 250 mg/dL (“time with hyperglycemia”), (iv) percentage of time with low blood sugar, defined as blood sugar of 60 mg/dL or less, (v) percentage of time with very low blood sugar, defined as blood sugar below 50 mg/dL, (vi) percentage of time in normal range, defined as blood sugar greater than 60 mg/dL and equal to or less than 180 mg/dL, and (iii) “hyperglycemia index”, calculated as the fraction of time with blood sugar level over 250 mg/dL multiplied by the average magnitude of the these hyperglycemic periods (defined as the difference in mg/dL between the recorded blood sugar level and 250).

The results are provided below in Table 2.

TABLE 2

| | | Experimental |
|---|---|---|
| | Control Period | Treatment Period |
| Average Blood Sugar (mg/dL) | 141.9 | 138.5 |
| % Time with High Blood Sugar | 16.2 | 16.4 |
| % Time with Hyperglycemia | 2.00 | 1.98 |
| % Time with Low Blood Sugar | 1.29 | 2.14 |
| % Time with Very Low Blood Sugar | 0.52 | 0.63 |
| % Time in Normal Range | 82.6 | 81.5 |
| Hyperglycemia Index | 0.88 | 0.58 |

This subject had a starting A1C level of 6.2 just prior to the experimental treatment period, which is an unusually low A1C level and average blood sugar level for a person with type 1 diabetes. This subject exercises regularly, is careful with his diet, and often consumes a dietary supplement to reduce the duration and magnitude of hyperglycemic events on occasions when his blood sugar rises above 300 mg/dL or so. Accordingly, he is perhaps not an ideal test subject since his baseline measurements are quite good. As is apparent from the data table above, the experimental treatment modestly reduced blood sugar levels, and had a fairly large impact on the subject's Hyperglycemia Index. However, the percentage of time within the normal blood sugar range was slightly higher during the control period, and the percentage of time with low blood sugar was higher on the experimental treatment.

Example 3. A pilot, open-label observational study was conducted on a male subject with type 1 diabetes. The subject used a Dexcom® continuous glucose monitoring system which recorded blood sugar levels every five minutes. The subject completed an extensive washout period for over roughly three months prior to the extended 33-day control period of this Example 3 to determine background blood sugar levels.

Subsequently, the subject self-administered nutraceutical compositions on a twice-daily basis within thirty minutes before meals, typically breakfast and dinner. The nutraceutical compositions that were ingested by the subject prior to meals comprised 7.5 g allulose, 3.75 g tagatose, and 0.5 g ginger. The treatment period extended for 87 days.

Blood sugar levels were recorded every five minutes using the continuous glucose monitoring system. Primary endpoints were (i) average blood sugar level over the course of treatment, (ii) percentage of time with blood sugar level over 180 mg/dL (“time with high blood sugar”), (iii) percentage of time with blood sugar level above 250 mg/dL (“time with hyperglycemia”), (iv) percentage of time with low blood sugar, defined as blood sugar of 60 mg/dL or less, (v) percentage of time with very low blood sugar, defined as blood sugar below 50 mg/dL, (vi) percentage of time in normal range, defined as blood sugar greater than 60 mg/dL and equal to or less than 180 mg/dL, and (iii) “hyperglycemia index”, calculated as the fraction of time with blood sugar level over 250 mg/dL multiplied by the average magnitude of the these hyperglycemic periods (defined as the difference in mg/dL between the recorded blood sugar level and 250).

The results are provided below in Table 3.

TABLE 3

| | | Experimental |
|---|---|---|
| | Control Period | Treatment Period |
| Average Blood Sugar (mg/dL) | 162.0 | 151.0 |
| % Time with High Blood Sugar | 34.0 | 25.6 |
| % Time with Hyperglycemia | 7.64 | 4.65 |
| % Time with Low Blood Sugar | 0.59 | 0.93 |
| % Time with Very Low Blood Sugar | 0.18 | 0.18 |
| % Time in Normal Range | 65.4 | 73.5 |
| Hyperglycemia Index | 3.06 | 1.39 |

As is apparent from the data table above, the experimental treatment significantly reduced average blood sugar levels, percentage of time with high blood sugar, and percentage of time with hyperglycemia. The percentage of time in normal blood sugar range increased significantly when using the experimental treatment. The percentage of time with low blood sugar increased when using the experimental treatment, although there was no change in the percentage of time with very low blood sugar (i.e., below 50 mg/dL). The experimental treatment had a large impact on the subject's Hyperglycemia Index, decreasing it by more than a factor of two.

An analysis of the effects of the experimental treatment over time showed very little differences in the response during the first 42 days of experimental treatment relative to the next 31 days of experimental treatment (e.g., average blood sugar was the same to within less than 0.1 mg/dL).

The subject continued with the experimental treatment for another 89 days, with continued good results as shown in Table 4, which provides the data for the second 89-day period as well as the first 87-day period.

TABLE 4

| | Experimental | Experimental |
|---|---|---|
| | Treatment | Treatment |
| | Period 2 | Period 1 |
| Average Blood Sugar (mg/dL) | 153.4 | 151.0 |
| % Time with High Blood Sugar | 27.4 | 25.6 |
| % Time with Hyperglycemia | 5.2 | 4.65 |
| % Time with Low Blood Sugar | 0.89 | 0.93 |
| % Time with Very Low Blood Sugar | 0.16 | 0.18 |
| % Time in Normal Range | 71.7 | 73.5 |
| Hyperglycemia Index | 1.57 | 1.39 |

### Example 4

A male subject with prediabetes consumed a nutraceutical composition comprising between 6 and 9 grams tagatose, between 4 and 6 grams allulose, and between 0.4 and 0.6 grams ginger prior to breakfast and dinner for 15 days. The nutraceutical composition was in the form of a wafer made by molding a mixture of water, tagatose, allulose, and ginger powder, followed by drying. No significant side effects were observed during the treatment period. The subject unintentionally lost roughly 2% of his body weight, although it is not known if the nutraceutical composition had any role in the weight loss.

Example 5. A pilot, open-label observational study was conducted on a 30-year-old male subject with type 1 diabetes, the same subject as in Examples 1 and 2. The subject used a Dexcom® continuous glucose monitoring system which recorded blood sugar levels every five minutes. Following the completion of Example 2, the subject did not complete a washout period, but instead continued treatment twice-daily with the same nutraceutical composition. However, rather than administering the nutraceutical composition prior to meals, the subject administered the nutraceutical composition within 30 minutes after meals. The nutraceutical compositions that were ingested by the subject following meals comprised 7.5 g allulose, 3.75 g tagatose, and 0.5 g ginger. The treatment period extended for 65 days.

Blood sugar levels were recorded every five minutes using the continuous glucose monitoring system. Primary endpoints were (i) average blood sugar level over the course of treatment, (ii) percentage of time with blood sugar level over 180 mg/dL (“time with high blood sugar”), (iii) percentage of time with blood sugar level above 250 mg/dL (“time with hyperglycemia”), (iv) percentage of time with low blood sugar, defined as blood sugar of 60 mg/dL or less, (v) percentage of time with very low blood sugar, defined as blood sugar below 50 mg/dL, (vi) percentage of time in normal range, defined as blood sugar greater than 60 mg/dL and equal to or less than 180 mg/dL, and (iii) “hyperglycemia index”, calculated as the fraction of time with blood sugar level over 250 mg/dL multiplied by the average magnitude of the these hyperglycemic periods (defined as the difference in mg/dL between the recorded blood sugar level and 250).

The results are provided below in Table 5 as “post-meal treatment” and are compared to the “pre-meal treatment” data previously provided in Example 2. The average blood sugar levels were slightly higher during the post-meal treatment period than during the pre-meal treatment period. During the collective treatment period described in Example 2 and this Example 5, the subject dropped roughly 5% of his body weight.

TABLE 2

| | Post-Meal | Pre-Meal |
|---|---|---|
| | Treatment | Treatment |
| | Period | Period |
| Average Blood Sugar (mg/dL) | 140.7 | 138.5 |
| % Time with High Blood Sugar | 15.9 | 16.4 |
| % Time with Hyperglycemia | 2.16 | 1.98 |
| % Time with Low Blood Sugar | 1.74 | 2.14 |
| % Time with Very Low Blood Sugar | 0.72 | 0.63 |
| % Time in Normal Range | 82.4 | 81.5 |
| Hyperglycemia Index | 0.58 | 0.58 |

### Example 6

A male subject with prediabetes tested the effects of consuming a nutraceutical composition comprising tagatose and allulose on post-prandial blood glucose levels. Each morning, prior to eating a standardized breakfast and again one hour after finishing the breakfast, a blood glucose meter was used to measure blood glucose levels. On half of the days, the subject consumed a chia pudding nutraceutical composition just prior to breakfast (after testing blood sugar). On the other half of the days, the subject consumed nothing before breakfast. On all days, the breakfast consisted of (i) water, (ii) 150 g plain Greek yogurt which included 50 g blueberry and 5 g honey, (iii) followed by 81 g granola cereal+120 g whole milk. After eating, the subject sat in a lounge chair working quietly on a laptop computer for 60 minutes, then self-administered a blood glucose test.

The nutraceutical composition included 5 g tagatose, 5 g allulose, 0.2 g ginger powder, 0.7 g psyllium, and 13.5 g chia seeds. To this dry solid mix was added sufficient unflavored soy milk to swell the chia seeds, which quickly firmed to a pudding texture in a refrigerator.

The subject showed very minimal increases in blood glucose on control days, with post-prandial blood glucose levels only rising an average of 3.5 mm/dL relative to pre-breakfast levels. When the nutraceutical chia pudding composition was consumed before meals, post-prandial blood glucose levels dropped an average of 8.5 mg/dL relative to pre-breakfast levels. Unfortunately, lack of a continuous glucose monitor restricted the ability to gather data at more time points. Nevertheless, the treatment showed a promising ability to reduce post-prandial blood glucose levels.

### INCORPORATION BY REFERENCE

All publications, patents, and patent applications cited herein are hereby expressly incorporated by reference in their entirety and for all purposes to the same extent as if each was so individually denoted.

### EQUIVALENTS

While specific embodiments of the subject invention have been discussed, the above specification is illustrative and not restrictive. Many variations of the invention will become apparent to those skilled in the art upon review of this specification. The full scope of the invention should be determined by reference to the claims, along with their full scope of equivalents, and the specification, along with such variations.

1. A nutraceutical composition useful for administering to human subjects with diabetes or prediabetes comprising tagatose, allulose, and ginger;
wherein said composition comprises between 0.25 g and 14 g tagatose;
wherein said composition comprises between 0.25 g and 14 g allulose;
wherein said composition comprises between 25 mg and 1.5 g ginger.

2. The nutraceutical composition of claim 1, wherein said composition is a dietary supplement composition in the form of a tablet, capsule, or gummy.

3. The dietary supplement composition of claim 2, wherein said dietary supplement composition is a chewable tablet or gummy.

4. The dietary supplement composition of claim 2, wherein said dietary supplement composition comprises less than 0.5 g of a sweetener having a glycemic index of greater than 40.

5. The dietary supplement composition of claim 2, wherein the weight ratio of tagatose to allulose is between 0.1 and 10.

6. The dietary supplement composition of claim 5, wherein the weight ratio of tagatose to allulose is between 0.25 and 2.

7. The dietary supplement composition of claim 2, wherein the recommended daily dosage of allulose and tagatose combined is between about 0.15 grams tagatose and allulose combined per kg body weight of the human subject and 0.6 grams tagatose and allulose combined per kg body weight of the human subject.

8. The dietary supplement composition of claim 7, wherein the weight ratio of tagatose to allulose is between 0.1 and 10.

9. The dietary supplement composition of claim 2, additionally comprising at least one vitamin.

10. The dietary supplement composition of claim 2, additionally comprising at least 20 additional dietary ingredients selected from the group consisting of vitamins and minerals.

11. The nutraceutical composition of claim 1, wherein said nutraceutical composition is a food item.

12. The nutraceutical composition of claim 1, wherein said nutraceutical composition is a beverage.

13. A method for managing blood sugar levels in a human subject comprising administering a nutraceutical composition before a meal,
wherein said nutraceutical composition comprises tagatose, allulose, and an agent useful for soothing an upset stomach;
wherein said composition comprises between 0.25 g and 14 g tagatose;
wherein said composition comprises between 0.25 g and 14 g allulose;
wherein said composition comprises between 5 mg and 1.5 g of said agent useful for treating an upset stomach;
wherein said agent useful for treating an upset stomach is selected from the group consisting of fennel, licorice, ginger, cinnamon, and mint; and
wherein said composition is administered within about 30 minutes prior to commencement of eating a meal by said subject.

14. The method of claim 13, wherein said nutraceutical composition is administered multiple times per day within 30 minutes prior to commencement of eating a meal by said subject.

15. The method of claim 13, wherein said nutraceutical composition is administered for at least 15 days.

16. The method of claim 13, wherein said nutraceutical composition further comprises at least one vitamin.

17. The method of claim 13, wherein said nutraceutical composition is a chewable tablet or gummy.

18. The method of claim 13, wherein said nutraceutical composition is administered to a subject with diabetes or prediabetes.

19. The method of claim 13, wherein said nutraceutical composition is administered to a subject with diabetes or prediabetes,
wherein relative to a control period during which said subject was not administered said nutraceutical composition, said subject experiences a therapeutic benefit selected from the group consisting of reduced hyperglycemic events, reduced average blood sugar level, reduced hemoglobin A1C percentage, reduced severe hyperglycemic index, and reduced weight.

20. The method of claim 13 wherein the weight ratio of tagatose to allulose in said nutraceutical composition is between 0.1 and 10;
wherein said nutraceutical composition is administered to said human subject at least twice per day within 30 minutes of onset of meal consumption by said subject; and
wherein said nutraceutical composition is administered at a daily dosage of between 0.15 grams tagatose and allulose combined per kg body weight of the human subject and 0.6 grams tagatose and allulose combined per kg body weight of the human subject.
